(19) United States
(12) Patent Application Publication
(10) Pub. No.: US 2020/0033878 A1
(43) Pub. Date: Jan. 30, 2020

(54) VACUUM CLEANER

(71) Applicant: TOSHIBA LIFESTYLE PRODUCTS & SERVICES CORPORATION, Kawasaki-shi (JP)

(72) Inventors: Kota WATANABE, Owariasahi (JP); Yuuki MARUTANI, Nagakute (JP)

(73) Assignee: TOSHIBA LIFESTYLE PRODUCTS & SERVICES CORPORATION, Kawasaki-shi (JP)

(21) Appl. No.: 16/605,132

(22) PCT Filed: May 22, 2018
(86) PCT No.: PCT/JP2018/019659

§ 371 Date: Oct. 14, 2019

(30) Foreign Application Priority Data
May 23, 2017 (JP) 2017-101946

(51) Int. Cl. G05D 1/02; A47L 9/28; A47L 11/40

(52) U.S. Cl. CPC G05D 1/0246; A47L 9/2805; G05D 2201/0203; G05D 1/0274; A47L 2201/04; A47L 11/4061

(57) ABSTRACT

A vacuum cleaner includes a main casing, driving wheels, a cleaning unit, a map generation part including a function of a self-position estimation part, a discrimination part, a route setting part, and a travel control part. The discrimination part discriminates the type of a floor surface. The route setting part sets a traveling route on the basis of the map generated by the map generation part and the type of a floor surface discriminated by the discrimination part. The travel control part controls the driving of the driving wheels to make the main casing autonomously travel along the traveling route set by the route setting part. The vacuum cleaner can efficiently clean depending on the type of a floor surface.

### TECHNICAL FIELD

Embodiments described herein relate generally to a vacuum cleaner capable of traveling autonomously.

### BACKGROUND ART

Conventionally, a so-called autonomously-traveling type vacuum cleaner (a cleaning robot) has been known, which cleans a cleaning-object surface while autonomously traveling on the cleaning-object surface. Some of such vacuum cleaners not only detect an obstacle, but also generate a map indicating the size and shape of a cleaning area by including a camera as an example, and additionally use a technique of estimating the self-position thereof, thereby allowing efficient autonomous traveling.

However, the above configuration provides traveling without the consideration of the types of floor surfaces, and accordingly some problems arise. In an example, a vacuum cleaner may travel against the mesh direction of a tatami mat, or fine dust and dirt in the grooves of flooring may be left.

In this respect, some of vacuum cleaners, which include, for example, a switch for selecting the type of a floor surface, detect the mesh directions of tatami mats on the basis of the arrangement of the tatami mats at the time when a tatami mode is selected, and autonomously travel on the basis of a traveling direction. Some other vacuum cleaners detect the arrangement of tatami mats by use of advanced and complicated image analysis, and thereby set a traveling route.

However, there are various types of floor surfaces, not only tatami but also flooring, carpet or the like, and appropriate traveling routes vary depending on the types of floor surfaces. Accordingly, a vacuum cleaner is preferably capable of easily and automatically discriminating the types of floor surfaces, and thereby setting appropriate traveling routes depending on the types.

### CITATION LIST

### Patent Literature

PTL 1: Unexamined Patent Publication No. 2007-319485

PTL 2: Unexamined Patent Publication No. 2014-79515

### SUMMARY OF INVENTION

### Technical Problem

The technical problem to be solved by the present invention is to provide a vacuum cleaner capable of efficient cleaning depending on the type of a cleaning-object surface.

### Solution to Problem

A vacuum cleaner of the embodiment has a main body, a travel driving part, a cleaning unit, a self-position estimation part, a mapper, a discrimination part, a setting part, and a travel controller. The travel driving part allows the main body to travel. The cleaning unit performs cleaning. The self-position estimation part estimates a self-position. The mapper generates a map of a cleaning area on the basis of the estimation of the self-position by the self-position estimation part. The discrimination part discriminates the type of a cleaning-object surface. The setting part sets a traveling route on the basis of the map generated by the mapper and the type of the cleaning-object surface discriminated by the discrimination part. The travel controller controls driving of the travel driving part to make the main body autonomously travel along the traveling route set by the setting unit.

### BRIEF DESCRIPTION OF DRAWINGS

FIG. 1 is a block diagram illustrating a vacuum cleaner according to one embodiment;

FIG. 2 is a perspective view illustrating the above vacuum cleaner;

FIG. 3 is a plan view illustrating the above vacuum cleaner as viewed from below;

FIG. 4 is an explanatory view schematically illustrating the method of calculating a three-dimensional coordinate of an object by the above vacuum cleaner;

FIG. 5(a) is an explanatory view schematically illustrating one example of the image captured by one camera, FIG. 5(b) is an explanatory view schematically illustrating one example of the image captured by the other camera, and FIG. 5(c) is an explanatory view illustrating one example of a parallax image based on the images of FIG. 5(a) and FIG. 5(b);

FIG. 6 is an explanatory view illustrating specific shapes in the images captured by the cameras of the above vacuum cleaner;

FIG. 7 (a) is a perspective view illustrating tatami mats as a first cleaning-object surface, FIG. 7 (b) is a perspective view illustrating flooring as a second cleaning-object surface, and FIG. 7(c) is a perspective view illustrating a rug type as a third cleaning-object surface;

FIG. 8(a) is an explanatory view illustrating one example of arrangement of tatami mats, and FIG. 8(b) is an explanatory view illustrating another example of arrangement of tatami mats;

FIG. 9(a) is an explanatory view illustrating one example of arrangement of tatami mats in a cleaning area having a four-and-a-half-mat area, FIG. 9(b) is an explanatory view illustrating one example of arrangement of tatami mats in a six-mat area, and FIG. 9(c) is an explanatory view illustrating one example of arrangement of tatami mats in an eight-mat area;

FIG. 10(a) is an explanatory view illustrating a traveling route corresponding to FIG. 9(a), FIG. 10(b) is an explanatory view illustrating a traveling route corresponding to FIG. 9(b), and FIG. 10(c) is an explanatory view illustrating a traveling route corresponding to FIG. 9(c);

FIG. 11(a) is an explanatory view enlargedly illustrating one example of a turning position in the traveling route in the case of tatami mat, and FIG. 11(b) is an explanatory view enlargedly illustrating another example of a turning position in a traveling route in the case of tatami mat; and

FIG. 12 is a flowchart indicating control of the above vacuum cleaner.

### DESCRIPTION OF EMBODIMENT

The configuration of one embodiment will be described below with reference to the drawings.

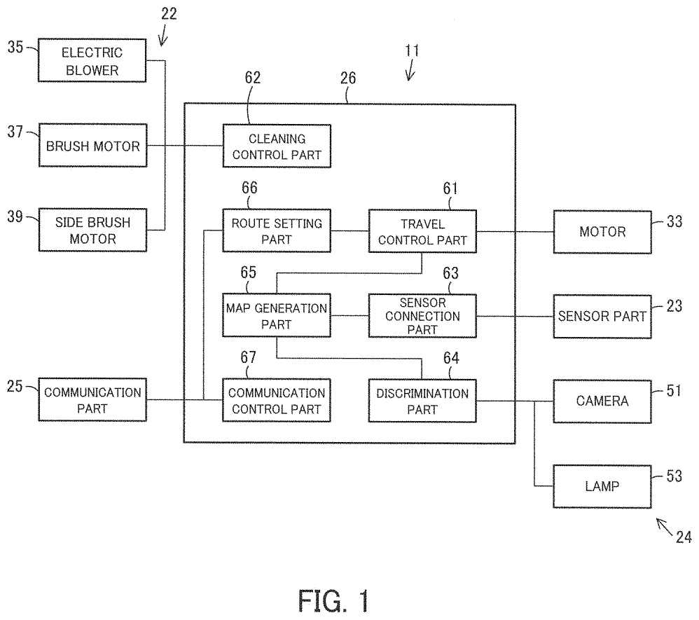

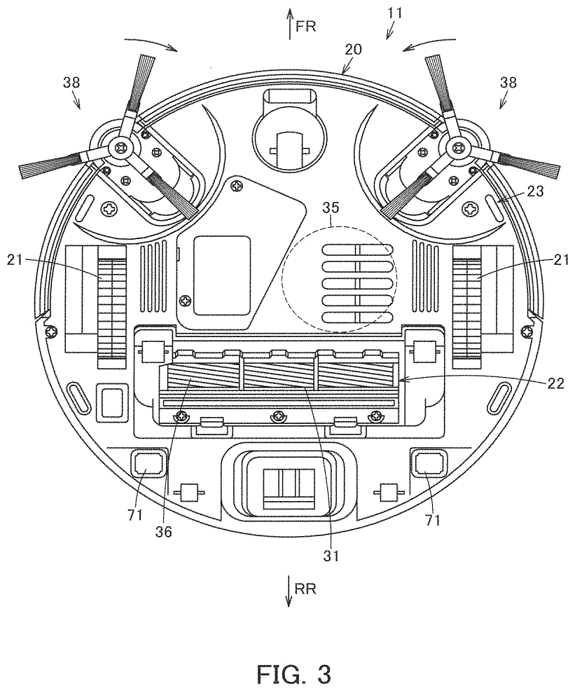

In FIG. 1 to FIG. 5, reference sign 11 denotes a vacuum cleaner as an autonomous traveler. Then, in the present embodiment, the vacuum cleaner 11 is a so-called self-propelled robot cleaner (a cleaning robot), which cleans a floor surface that is a cleaning-object surface as a traveling surface, while autonomously traveling (self-traveling) on the floor surface. It is noted that the vacuum cleaner 11 may constitute, for example, a vacuum cleaning apparatus (a vacuum cleaning system), serving as an autonomous traveler device, in combination with a charging device (a charging table) not shown, serving as a station device corresponding to abase station for charging the vacuum cleaner 11.

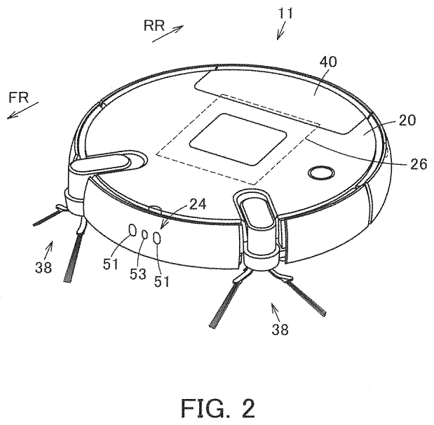

The vacuum cleaner 11 includes a main casing 20 which is a hollow main body. The vacuum cleaner 11 further includes driving wheels 21, serving as a travel driving part. The vacuum cleaner 11 further includes a cleaning unit 22 for removing dust and dirt. The vacuum cleaner 11 further includes a sensor part 23. The vacuum cleaner 11 further includes an image capturing part 24. The vacuum cleaner 11 further includes a communication part 25. The vacuum cleaner 11 further includes a control part 26, serving as control means which is a controller. The vacuum cleaner 11 may further include an indication part, serving as indication means for indicating an image. The vacuum cleaner 11 may further include a secondary battery which is a battery for power supply. The vacuum cleaner 11 may further include a communication part which is data communication means, serving as information transmission means for performing, for example, wired communication or wireless communication via a network. The vacuum cleaner 11 may further include an input/output part which exchanges signals with an external device and/or a user. It is noted that the following description will be given on the basis that a direction extending along the traveling direction of the vacuum cleaner 11 (the main casing 20) is treated as a back-and-forth direction (directions of an arrow FR and an arrow RR shown in FIG. 2), while a left-and-right direction (directions toward both sides) intersecting (orthogonally crossing) the back-and-forth direction is treated as a widthwise direction.

The main casing 20 is formed of, for example, synthetic resin. The main casing 20 may be formed into, for example, a flat columnar shape (a disk shape). Moreover, the main casing 20 may have a suction port 31 or the like which is a dust-collecting port, in the lower part or the like facing the floor surface.

The driving wheels 21 are used to make the vacuum cleaner 11 (the main casing 20) travel (autonomously travel) on the floor surface in the advancing direction and the retreating direction, that is, serve for traveling use. In the present embodiment, the driving wheels 21 are disposed in a pair, for example, on the left and right sides of the main casing 20. The driving wheels 21 are driven by motors 33, serving as driving means. It is noted that a crawler or the like may be used as a travel driving part, instead of these driving wheels 21.

The motors 33 are disposed to correspond to the driving wheels 21. Accordingly, in the present embodiment, the motors 33 are disposed in a pair, for example, on the left and right sides. Then, the motors 33 are capable of independently and respectively driving each of the driving wheels 21.

The cleaning unit 22 is configured to remove dust and dirt existing on a cleaning-object part, for example, a floor surface or a wall surface or the like. In an example, the cleaning unit 22 has the function of collecting and catching dust and dirt existing on a floor surface through the suction port 31, and/or wiping a wall surface. The cleaning unit 22 may include at least one of an electric blower 35 for sucking dust and dirt together with air through the suction port 31, a rotary brush 36, serving as a rotary cleaner rotatably attached to the suction port 31 to scrape up dust and dirt and a brush motor 37 for rotationally driving the rotary brush 36, side brushes 38 which are auxiliary cleaning means (auxiliary cleaning parts), serving as swinging cleaning parts rotatably attached on the both sides of the main casing 20 on its front side or the like to scrape up dust and dirt and side brush motors 39 for driving the side brushes 38. The cleaning unit 22 may further include a dust-collecting unit 40 which communicates with the suction port 31 to accumulate dust and dirt.

The sensor part 23 is configured to sense various types of information which are used to support the traveling of the vacuum cleaner 11 (the main casing 20). More specifically, the sensor part 23 is configured to sense, for example, pits and bumps (a step gap) of the floor surface, a wall or an obstacle corresponding to a traveling obstacle, and an amount of dust and dirt on the floor surface, or the like. For example, an infrared sensor or an ultrasonic sensor or the like serves as the sensor part 23.

The image capturing part 24 includes a camera 51, serving as image capturing means (an image-pickup-part main body). Moreover, the image capturing part 24 may include a lamp 53, serving as detection assisting means (a detection assisting part).

The camera 51 is a digital camera for capturing digital images in the forward direction which is the traveling direction of the vacuum cleaner 11 (the main casing 20), at a specified horizontal angle of view (for example, 105 degrees or the like) and at specified time intervals, for example, at a micro-time basis such as several tens of milliseconds or the like, at a several-second basis or the like. That is, the camera 51 is configured to capture images of the range covering a floor surface and a wall surface in front of the vacuum cleaner 11 (the main casing 20). The camera 51 may be configured with one camera, or with plural cameras. In the present embodiment, the cameras 51 are disposed in a pair on the left and right sides. That is, the cameras 51 are disposed apart from each other on the left side and the right side of the front portion of the main casing 20. Moreover, the cameras 51, 51 have image ranges (fields of view) overlapping with each other. Accordingly, the image regions of the images captured by these cameras 51, 51 overlap with each other in the left-and-right direction. It is noted that the camera 51 may capture, for example, a color image or a black/white image in a visible light region, or an infrared image.

The lamp 53 is configured to irradiate the image ranges of the cameras 51 to provide brightness required for image capturing. In the present embodiment, the lamp 53 is disposed at an intermediate portion between the cameras 51, 51 so as to correspond to the cameras 51. For example, an LED light serves as the lamp 53.

The communication part 25 is capable of performing wired or wireless communication with a general-purpose server, serving as data storage means (a data storage part), or an external device or the like, via a network (an external network) such as the Internet, by performing communication (transmission/reception of data) with a home gateway (a router), for example, serving as relay means (a relay part) disposed in a cleaning area or the like, by using wired communication or wireless communication such as Wi-Fi (registered trademark) or Bluetooth (registered trademark) or the like. For example, a wireless LAN device preferably serves as the communication part 25. It is noted that the communication part 25 may have, for example, an access point function so as to perform wireless communication directly with an external device without a home gateway. Moreover, the communication part 25 may additionally have, for example, a web server function.

A microcomputer serves as the control part 26, and the microcomputer includes, for example, a CPU corresponding to a control means main body (a control part main body), a ROM, a RAM or the like. The control part 26 includes a travel control part 61 which is travel control means for driving the driving wheels 21 (the motors 33). The control part 26 further includes a cleaning control part 62 which is cleaning control means electrically connected to the cleaning unit 22. The control part 26 further includes a sensor connection part 63 which is sensor control means electrically connected to the sensor part 23. The control part 26 further includes a discrimination part 64 which is discrimination means electrically connected to the image capturing part 24. The control part 26 further includes a map generation part 65 which is mapping means (a mapping part). That is, the control part 26 is electrically connected to the cleaning unit 22, the sensor part 23, the image capturing part 24, the communication part 25 or the like. The control part 26 further includes a route setting part 66, serving as setting means for setting a traveling route of the vacuum cleaner 11 (the main casing 20). The control part 26 further includes a communication control part 67 electrically connected to the communication part 25. Moreover, in the case of the vacuum cleaner 11 including the indication means, the control part 26 may include an indication control part electrically connected to the indication means. Furthermore, the control part 26 is electrically connected to the secondary battery. It is noted that the control part 26 may include a non-volatile memory, for example, a flash memory. Moreover, the control part 26 may include a charging control part for controlling the charging of the secondary battery. Furthermore, in the present embodiment, the control part 26 includes the travel control part 61, the cleaning control part 62, the sensor connection part 63, the discrimination part 64, the map generation part 65, the route setting part 66, the communication control part 67, the indication control part, and the charging control part. Alternatively, these control parts may be provided separately from the control part 26. Further alternatively, arbitrary control parts among them may be combined and integrated with the control part 26, or may be combined and provided as one unit separately from the control part 26.

The travel control part 61 controls the driving of the motors 33. That is, the travel control part 61 controls a magnitude and a direction of the current flowing through each of the motors 33 to rotate each of the motors 33 in a normal or reverse direction, thereby controlling the driving of each of the motors 33. By controlling the driving of each of the motors 33, the travel control part 61 controls the driving of each of the driving wheels 21. The travel control part 61 is configured to control the driving of the driving wheels 21 (the motors 33) so as to make the vacuum cleaner 11 (the main casing 20) travel along the traveling route set by the route setting part 66.

The cleaning control part 62 controls the driving of the electric blower 35, the brush motor 37 and the side brush motors 39 of the cleaning unit 22. That is, the cleaning control part 62 individually controls the current-carrying quantities of the electric blower 35, the brush motor 37 and the side brush motors 39, thereby controlling the driving of the electric blower 35, the brush motor 37 (the rotary brush 36) and the side brush motors 39 (the side brushes 38). That is, the cleaning control part 62 includes at least one of the function of electric blower control means (an electric blower control part) of controlling the driving of the electric blower 35, the function of rotation control means (a rotation control part) of controlling the rotation of the rotary brush 36 (the brush motor 37), and the function of auxiliary rotation control means (an auxiliary rotation control part) of controlling the driving of the side brushes 38 (the side brush motors 39).

The sensor connection part 63 is configured to acquire the detection result obtained by the sensor part 23.

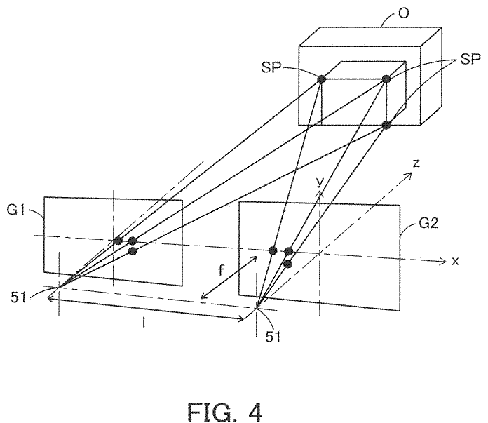

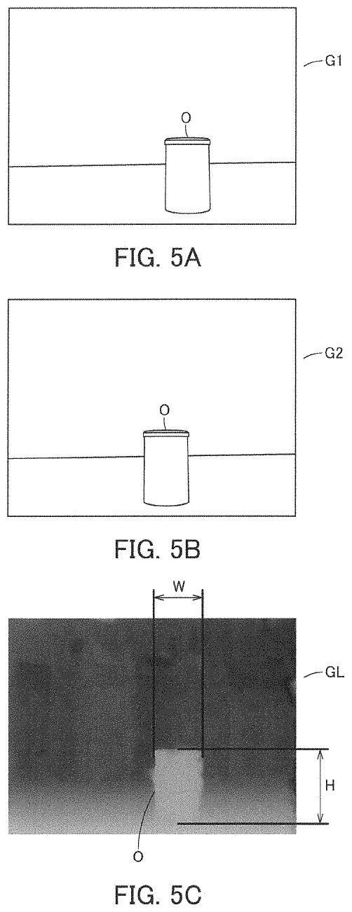

The discrimination part 64 is configured to detect and discriminate the shape (distance, height or the like) of an object (such as an obstacle) existing in the vicinity of the vacuum cleaner 11 (the main casing 20), by extracting feature points or the like from the images captured by the cameras 51. In an example, the discrimination part 64 is configured to calculate a distance (depth) and three-dimensional coordinates of an object (feature points) by a known method, on the basis of the images captured by the cameras 51, and the distance between the cameras 51. That is, more specifically, the discrimination part 64 is configured to apply triangulation based on a distance f (parallax) from the cameras 51, 51 to an object O (feature points SP) in images G1, G2 captured by the cameras 51, 51 and a distance I between the cameras 51, 51 to detect pixel dots indicative of identical positions in the individual images G1, G2 captured by the cameras 51, 51 and to calculate angles of the pixel dots in the up-and-down direction, the left-and-right direction and the back-and-forth direction, thereby calculating the heights and the distances of the positions from the cameras 51 on the basis of these angles and the distance I between the cameras 51, 51 and also calculating the three-dimensional coordinates of the object O (feature points SP) (FIG. 4). Therefore, the discrimination part 64 is capable of generating a parallax image (distance image) GL on the basis of the images G1, G2, and also capable of detecting a height H and a width W of the captured object O on the basis of the parallax image GL (FIG. 5(a), FIG. 5(b), FIG. 5(c)). It is noted that in the case of one camera serving as the camera 51, the discrimination part 64 may also calculate, when the vacuum cleaner 11 (the main casing 20) moves, the distance on the basis of the shift amount of a target object in the coordinate system.

Moreover, in an example, the discrimination part 64 is configured to compare the distance of the object captured by the cameras 51 in a predetermined image range (for example, an image range set so as to correspond to the wide and the height of the main casing 20), with a set distance corresponding to a threshold value previously set or variably set, thereby discriminating that the object positioned at a distance (a distance from the vacuum cleaner 11 (the main casing 20)) identical to the set distance or closer is an obstacle. Accordingly, the discrimination part 64 includes the function of an obstacle determination part for discriminating whether or not the object subjected to the calculation of the distance from the vacuum cleaner 11 (the main casing 20) based on the images captured by the cameras 51 is an obstacle. The function of the obstacle determination part may be provided integrally with the discrimination part 64, or may be provided separately from the discrimination part 64.

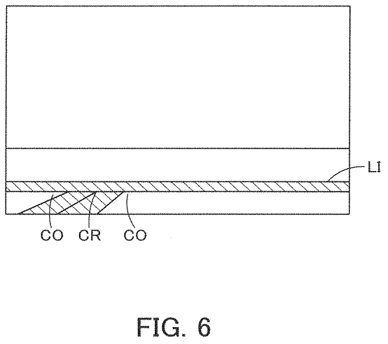

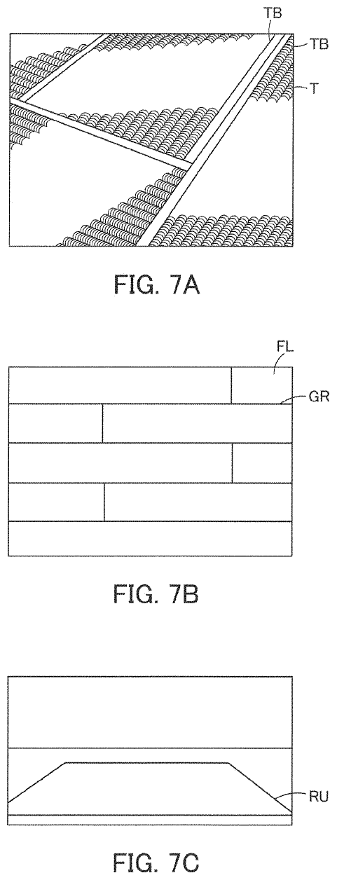

The discrimination part 64 further includes the function of discriminating the type of a floor surface. More specifically, the discrimination part 64 discriminates the type of a floor surface on the basis of specific shapes in the images captured by the cameras 51. The discrimination part 64 uses specific shapes, for example, a line LI, a corner CO or a cross point CR of lines (FIG. 6) positioned on the floor surface, to discriminate the type of a floor surface. In more detail, the discrimination part 64 discriminates the type of a floor surface on the basis of at least either the distribution of these specific shapes or the combination of these specific shapes. The discrimination part 64 discriminates the type of a floor surface, for example, a tatami mat T (FIG. 7(a)) as a first cleaning-object surface (floor surface), a flooring FL (FIG. 7(b)) as a second cleaning-object surface (floor surface), a rug type RU (FIG. 7(c)) such as a rug or a carpet as a third cleaning-object surface (floor surface), or another type of a floor surface as a fourth cleaning-object surface (floor surface). The discrimination of a floor surface by the discrimination part 64 will be detailed below.

It is noted that the discrimination part 64 may include an image correction function of performing primary image processing to the original images captured by the cameras 51, for example, correction of distortion of the lenses, noise cancellation, contrast adjusting, and matching the centers of images. The discrimination part 64 may further include the function of a camera control part of controlling the driving of the cameras 51 and the lamp 53.

The map generation part 65 is configured to generate a map indicating whether or not the vacuum cleaner 11 is able to travel in a cleaning area on the basis of a shape (the distance and the height of an object corresponding to an obstacle) in the vicinity of the vacuum cleaner 11 (the main casing 20) detected by the discrimination part 64 on the basis of the images captured by the cameras 51. Specifically, the map generation part 65 estimates the self-position of the vacuum cleaner 11 on the basis of the three-dimensional coordinates of the feature points of an object in the images captured by the cameras 51. The map generation part 65 further generates the map indicating the positional relation and the heights of the objects (obstacles) or the like positioned in a cleaning area detected by the discrimination part 64, on the basis of the estimated self-position. That is, the map generation part 65 includes the function of self-position estimation means (a self-position estimation part) of estimating the self-position of the vacuum cleaner 11. The map generation part 65 is able to use the known technology of simultaneous localization and mapping (SLAM). The map generated by the map generation part 65 may be stored in the map generation part 65, or may be stored in the memory (the storage part). It is noted that the map generation part 65 is also capable of storing (marking), in the map, the position of the specific shape of a floor surface, such as a line, a corner, or a cross point of lines.

The route setting part 66 is configured to set a traveling route of the vacuum cleaner 11 (the main casing 20) depending on the type of a floor surface discriminated by the discrimination part 64, on the basis of the map generated by the map generation part 65. That is, the route setting part 66 is capable of setting a traveling route for tatami mat, a traveling route for flooring, a traveling route for rug type, and a traveling route for another type of a floor surface. In the case where the map of the cleaning area has been generated already, the route setting part 66 sets a traveling route on the basis of the map. In the case where the map of the cleaning area has not been generated yet, the route setting part 66 sets a traveling route while the map generation part 65 generates the map. The specific method of setting a traveling route by the route setting part 66 will be detailed below.

The communication control part 67 controls the operation of the communication part 25, so that each type of information such as the map generated by the map generation part 65, the traveling route set by the route setting part 66 or the traveling track by the vacuum cleaner 11 (the main casing 20) is transmitted via the communication part 25 to an external device or the like. The communication control part 67 may be provided integrally with the communication part 25.

The indication control part controls the driving of the indication part to make the indication part indicate predetermined information. The indication control part may be provided integrally with the indication part.

Then, for example, an LCD or an LED serves as the indication part. The indication part may be disposed at a position visible to a user from the outside of the vacuum cleaner 11, for example, on the upper face of the main casing 20. It is noted that the indication part may be provided integrally with input means such as a touch panel allowing a user to directly input data such as an instruction.

The input/output part is configured to acquire a control command transmitted by an external device such as a remote control not shown, and/or a control command input through input means such as a switch or a touch panel disposed on the main casing 20, and also to transmit a signal to, for example, the charging device. The input/output part includes transmission means (a transmission part) not shown, reception means (a reception part) not shown, or the like. The transmission means is, for example, an infrared light emitting element for transmitting wireless signals (infrared signals) to, for example, the charging device. The reception means is, for example, a phototransistor for receiving wireless signals (infrared signals) from the charging device, the remote control or the like.

The secondary battery is configured to supply electric power to the cleaning unit 22, the sensor part 23, the image capturing part 24, the communication part 25, the control part 26 or the like. The secondary battery may be electrically connected to charging terminals 71, serving as connection parts, exposed and disposed at the lower portions of the main casing 20, as an example. Then, the secondary battery may be configured to be charged via the charging device, when the charging terminals 71 are electrically and mechanically connected to the side of the charging device.

The charging device incorporates a charging circuit, for example, a constant current circuit. Moreover, the charging device includes terminals for charging to be used to charge the secondary battery. The terminals for charging are electrically connected to the charging circuit. The terminals for charging are configured to be mechanically and electrically connected to the charging terminals 71 of the vacuum cleaner 11 when returning to the charging device.

The external device is a general-purpose device, for example, a PC (a tablet terminal (a tablet PC)) or a smartphone (a mobile phone), which is capable of, inside a building, performing wired or wireless communication with a network via, for example, the home gateway, and outside a building, performing wired or wireless communication with a network. The external device may have an indication function of indicating an image.

Then, the operation of the above-described embodiment is described below with reference to the drawings.

The outline from the start to the end of the cleaning is described first. When starting the cleaning, the vacuum cleaner 11 cleans a floor surface while traveling on the basis of the map, and updates the map as needed. After completing the cleaning, the vacuum cleaner 11 returns to the charging device, and thereafter is switched over to a standby mode or a work mode of charging the secondary battery.

In more detail of the above-described control, the vacuum cleaner 11 starts the cleaning at certain timing, for example, when a preset cleaning start time arrives or when the input/output part receives the control command to start the cleaning transmitted by the remote control or the external device. In the case where the vacuum cleaner 11 is connected to the charging device, the travel control part 61 controls the driving of the driving wheels 21 (the motors 33), so that the vacuum cleaner 11 undocks from the charging device and travels straight by a predetermined distance. Moreover, in the case where the vacuum cleaner 11 is not connected to the charging device, the vacuum cleaner 11 starts the cleaning from the position.

Then, in the case where the map has been generated already, the cleaning control part 62 operates the cleaning unit 22 to clean a floor surface in a cleaning area, while the travel control part 61 controls the driving wheels 21 (the motors 33) to make the vacuum cleaner 11 (the main casing 20) autonomously travel along a set traveling route. Moreover, in the case where the map has not been generated yet, the map generation part 65 generates the map and the route setting part 66 sets a traveling route (map generation operation), while the travel control part 61 controls the driving wheels (the motors 33) to make the vacuum cleaner 11 (the main casing 20) travel along a predetermined traveling route, at random, in zigzags or the like, and further while the cleaning control part 62 operates the cleaning unit 22 to perform the cleaning.

For example, the electric blower 35, the rotary brush 36 (the brush motor 37), or the side brushes 38 (the side brush motors 39) of the cleaning unit 22 driven by the cleaning control part 62 catches and collects dust and dirt on the floor surface through the suction port 31 into the dust-collecting unit 40. Moreover, while the vacuum cleaner 11 travels autonomously, the discrimination part 64 may detect the three-dimensional coordinates of an object such as an obstacle not indicated in the map stored in advance, on the basis of the images captured by the cameras 51, or may detect specific shapes of a floor surface not indicated in the map, or the sensor part 23 may detect a traveling obstacle not indicated in the map. In such cases, the map generation part 65 may also store such detected items in the map.

Then, when completing the traveling along a set traveling route, the vacuum cleaner 11 finishes the cleaning operation, and the travel control part 61 controls the driving of the driving wheels 21 (the motors 33) to make the vacuum cleaner 11 return to the charging device, and make the vacuum cleaner 11 connected to the charging device (so that the charging terminals 71 and the terminals for charging are mechanically and electrically connected to each other). The vacuum cleaner 11 is switched over to, for example, a charging operation or a standby operation, at predetermined timing, such as after a predetermined period of time passing after the connection.

The map generation operation described above is described in more detail.

The cameras 51 and the discrimination part 64 or the sensor part 23 discriminates the type of a floor surface or detects a traveling obstacle, while the travel control part 61 controls the driving of the driving wheels 21 (the motors 33) to make the vacuum cleaner 11 travel in a cleaning area along a predetermined traveling route, at random, in zigzags or the like (search traveling). The map generation part 65 generates the map reflecting the traveling obstacle and/or the type of the floor surface.

Specifically, while the vacuum cleaner 11 performs the search traveling after the start of the cleaning, in the case where the discrimination part 64 detects and discriminates an obstacle on the basis of the images captured by the cameras 51, or in the case where the sensor part 23 detects a traveling obstacle such as an obstacle, a wall or a step gap, the map generation part 65 stores, as the map, the position of the traveling obstacle on the basis of the estimated self-position of the vacuum cleaner 11. In this case, when the specific shapes of the floor surface are detected in the images captured by the cameras 51, the map generation part 65 further stores the positions of the specific shapes in the map.

In an example, in the case where a line is detected as a specific shape of the floor surface, the map generation part 65 stores the line in the map, and the travel control part 61 makes the vacuum cleaner 11 (the main casing 20) travel along the line. As described above, the travel control part 61 makes the vacuum cleaner 11 (the main casing 20) travel on the line. Thus, in the case where the type of the floor surface is, for example, tatami mat, and even further where the mesh direction of the tatami mat is not grasped yet, such traveling enables to prevent the driving wheels 21 or the rotary brush 36 from scratching the tatami mat. In the case where the type of the floor surface is flooring, such traveling enables to make the vacuum cleaner 11 travel along the groove discriminated as a line. In the case where the type of the floor surface is rug type, such traveling enables to make the vacuum cleaner 11 travel along the boundary discriminated as a line between the rug type and the floor surface under the rug type. Accordingly, in every case, such traveling enables to provide efficient cleaning. Further, in the case where, for example, a cross point such as a letter-T shape or a corner such as a letter-L shape is detected during the traveling on the line, such a detected item is stored in the map each time. After the traveling on all of the detected lines, the discrimination part 64 discriminates the type of the floor surface. That is, in the present embodiment, the travel control part 61 controls the driving of the driving wheels (the motors 33) to make the vacuum cleaner 11 (the main casing 20) travel along the lines until the discrimination part 64 discriminates the type of the floor surface. It is noted that the discrimination part 64 may discriminate the type of a floor surface during the traveling on a line.

The discrimination part 64 is capable of discriminating the type of a floor surface on the basis of, for example, the number and/or the interval of detected corners, or capable of discriminating the type on the basis of a plurality of specific shapes (combination of a plurality of specific shapes). Various types of methods for discriminating the type of a floor surface on the basis of the plurality of specific shapes (combination of the plurality of specific shapes) are available. In an example, the discrimination part 64 is capable of discriminating the type of a floor surface, on the basis of a width between lines, the minimum interval between cross points (letter-T shapes) or an interval between detected corners. Specifically, in the case where, for example, a width between lines is equal to a predetermined length or shorter, for example, 200 mm or shorter, the discrimination part 64 discriminates that the type of the floor surface is flooring. In the case where the minimum interval between cross points is equal to a predetermined length or longer, for example, 800 mm or longer, the discrimination part 64 discriminates that the type of the floor surface is tatami mat. In the case where an interval between detected corners is equal to a predetermined length or longer, for example, 500 mm or longer, the discrimination part 64 discriminates that the type of the floor surface is rug type. Moreover, even in the case where a rug type such as a carpet is partially arranged on flooring as an example, the discrimination part 64 is capable of discriminating the plural types of floor surfaces when the respective conditions are established. In this respect, if the discrimination part 64 is not able to discriminate the type of a floor surface, the floor surface is highly possibly, for example, a tile-like floor surface other than the types of flooring, tatami mat, and rug type. Therefore, the vacuum cleaner 11 is switched back to the search traveling so that the cameras 51, the discrimination part 64, the sensor part 23 or the like detect a traveling obstacle or the like under the generation of the map, and further continue the detection of the specific shapes of the floor surface.

Then, after the discrimination part 64 discriminates the type of a floor surface, the map generation part 65 registers the type of the floor surface in the map, and the route setting part 66 sets a traveling route.

The next descriptions are about specific methods executed by the route setting part 66 for setting a traveling route. The descriptions below are about the examples of the case where the type of a floor surface is discriminated to be tatami mat, the case where the type of a floor surface is discriminated to be flooring, and the case where the type of a floor surface is discriminated to be rug type.

In the case where the type of a floor surface is tatami mat, the vacuum cleaner 11 (the main casing 20) preferably travels along the mesh direction of the tatami mat.

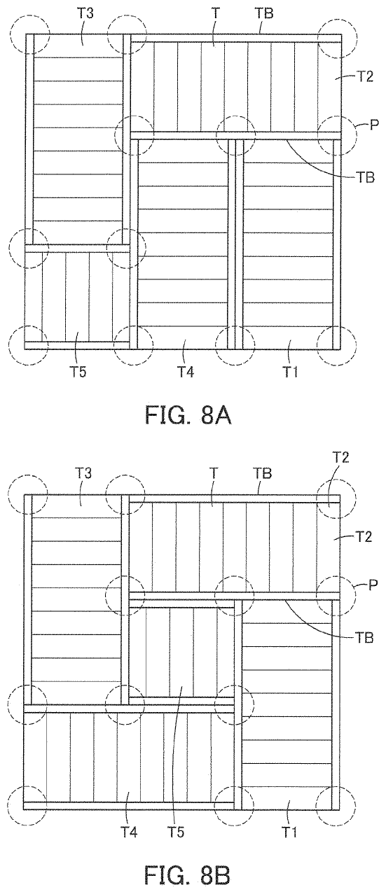

Accordingly, in the case where the discrimination part 64 discriminates that the type of a floor surface is tatami mat, the route setting part 66 sets a traveling route along the mesh directions of the tatami mats, on the basis of the arrangement of the tatami mats estimated on the basis of the distribution of specific shapes. In more detail, in the case where the type of a floor surface is discriminated to be tatami mat, the route setting part 66 estimates the arrangement of the tatami mats on the basis of the distribution of the detected specific shapes on the map before the type of the floor surface is discriminated to be tatami mat, and calculates the traveling route along the mesh directions of the tatami mats. The examples shown in FIG. 8(a) and FIG. 8(b) are described below, with respect to the arrangement of tatami mats T in the cleaning area having a so-called four-and-a-half-mat area.

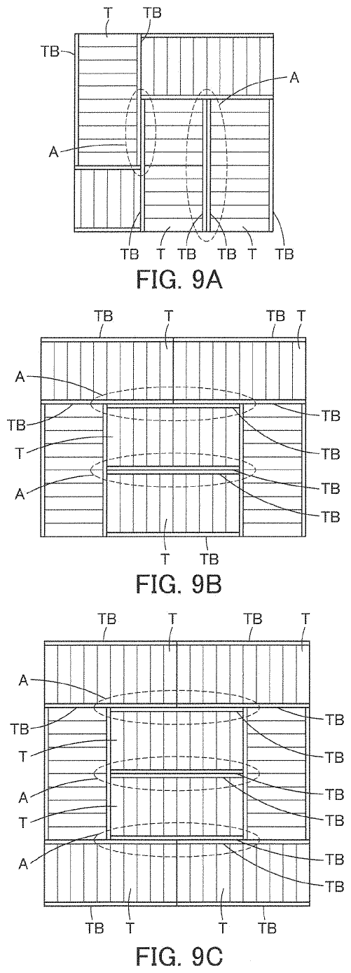

The route setting part 66 arranges the positions of the cross points and the corners (points P indicated with circles as shown in FIG. 8(a) or the like) on the map detected as specific shapes during when the vacuum cleaner 11 (the main casing 20) travels on the lines. The route setting part 66 calculates the intervals between the positions of the cross points and the corners. Then, in the case where some of the intervals between the positions thereof are equal to, for example, 1500 mm or longer, the route setting part 66 is able to discriminate that the corresponding portions are the long sides of the tatami mats. Moreover, there is not much difference in shapes among the several size types of the tatami mats, and the ratio of the long side and the short side thereof is 2:1. Moreover, the mesh directions of the tatami mats (indicated with thin lines in FIG. 8 and FIG. 9) are formed along the directions of the short sides between the two long sides. Therefore, once discriminating the positions of the long sides of the tatami mats, the route setting part 66 is able to easily discriminate the arrangement and the mesh directions of a tatami mat T1, a tatami mat T2, a tatami mat T3 and a tatami mat T4 each having a one-mat area shown in FIG. 8(a). On the other hand, as for a tatami mat having a half-mat area such as a tatami mat T5, the route setting part 66 is able to discriminate the arrangement thereof on the basis of the arrangement of the adjacent tatami mats. That is, there is a general rule of arranging tatami mats in Japanese tradition. A mat having a half-mat area is likely arranged so that the mesh direction thereof is not parallel to the mesh directions of the adjacent mats each having a one-mat area. Moreover, the arrangement of tatami mats in a swastika shape and the arrangement of tatami mats in a cross shape are called ill-fated arrangement and deemed as bad omens in Japanese tradition. Such arrangement of tatami mats is likely to be avoided in general. Accordingly, the route setting part 66 uses such rules of arranging tatami mats for discrimination of the mesh directions of tatami mats, thereby enabling to effectively discriminate the arrangement and the mesh direction of a tatami mat having a half-mat area.

Furthermore, in the case where the tatami mat T5 having a half-mat area is arranged substantially in the center of the cleaning area (FIG. 8(b)), the route setting part 66 uses the widths of the lines to discriminate the arrangement and the mesh direction of the tatami mat T5. In other words, the route setting part 66 is also able to set a traveling route on tatami mats on the basis of the widths of the lines. That is, a tatami border TB for reinforcement is arranged along a long side of each of the tatami mats T, and thus in the case where the tatami mat T5 having a half-mat area is arranged substantially in the center of the cleaning area, the two tatami borders TB of the tatami mat T5 and the adjacent tatami mat T are placed next to each other, whereby the line of the position has a double width. In this case, the map generation part 65 stores the position of the line having a double width in the map, whereby the route setting part 66 is able to discriminate the mesh directions of tatami mats by use of the information on the position of the line having a double width. Moreover, even in the case where, for example, cross points and corners are not sufficiently detected due to an obstacle, for example, furniture, the route setting part 66 is able to estimate the arrangement and the mesh directions of tatami mats by extracting the widths of lines.

The use of these estimation methods allows the route setting part 66 to estimate the arrangement of the tatami mats T, even in the case of the cleaning areas having various sizes as shown in FIG. 9(a), FIG. 9(b) and FIG. 9(c). That is, in the examples shown in FIG. 9(a), FIG. 9(b) and FIG. 9(c), the positions of areas A enclosed with broken lines are detected to correspond to the lines each having a double width since two tatami borders TB are adjacent to each other.

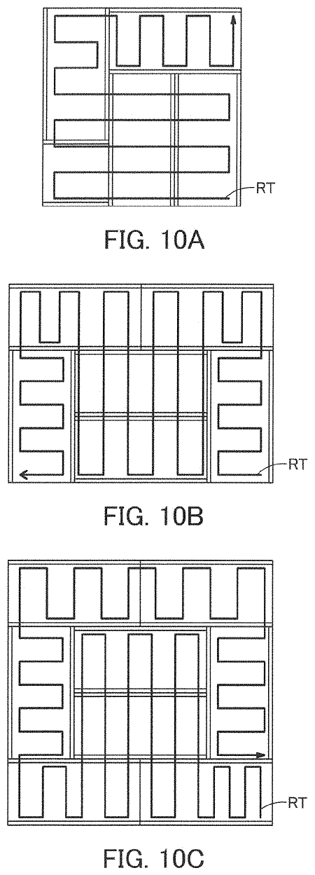

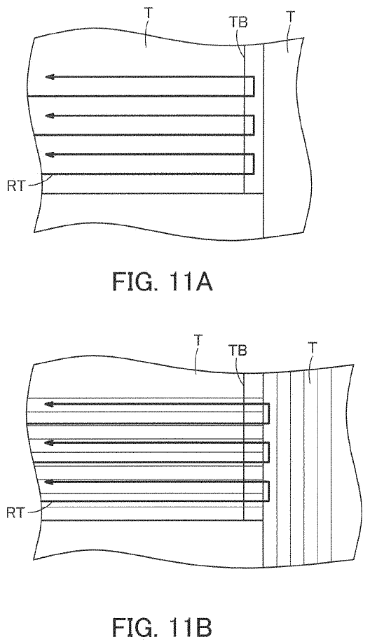

Thereafter, the route setting part 66 sets a traveling route so that the vacuum cleaner 11 travels basically in zigzags along the mesh directions. In an example, FIG. 10(a), FIG. 10(b) and FIG. 10(c) indicate the examples of traveling routes RT corresponding to FIG. 9(a), FIG. 9(b) and FIG. 9(c), respectively. In FIG. 10(a), FIG. 10(b) and FIG. 10(c), in order to provide clear description, turning points in the traveling routes RT are set inside the tatami mats T. Alternatively, such turning points in the traveling routes RT may be set on the tatami borders TB so that the traveling routes RT do not go against the mesh directions of the tatami mats T (FIG. 11(a)). Moreover, in the case where the mesh directions of two adjacent tatami mats are different from each other as an example (FIG. 11(b)), such turning points in the traveling route RT may be set so that the traveling route RT is extended to the adjacent tatami mat T, thereby also enabling to suppress the vacuum cleaner 11 from traveling against the mesh directions in turning.

Then, in the case where the discrimination part 64 discriminates that the type of a floor surface is flooring, the route setting part 66 sets a traveling route along grooves GR (FIG. 7(b)) on the basis of the distribution of specific shapes. In more detail, in the case where the discrimination part 64 discriminates that the type of a floor surface is flooring, the route setting part 66 sets a traveling route so that the vacuum cleaner 11 travels along a line which is adjacent specific shapes and turns at a position of an edge part of the specific shapes or the like, that is, so that the vacuum cleaner 11 travels in zigzags along lines. As a result, the cleaning unit 22 is able to effectively remove dust and dirt entering in the grooves of the flooring detected as lines.

Moreover, in the case where the discrimination part 64 discriminates that the type of a floor surface is rug type, the route setting part 66 estimates the area of the rug type on the basis of the distribution of specific shapes. In more detail, in the case where the discrimination part 64 estimates that the type of a floor surface is rug type, the route setting part 66 estimates the area of the rug type on the basis of the information on the boundaries between the rug type and the floor surface detected as lines, the positions of the four corners detected as corners or the like. The detection of at least two sides of the rug type allows such estimation. Then, the route setting part 66 preferably sets a traveling route allowing the vacuum cleaner 11 to remove the dust and dirt deeply intruding in the shaggy rug type, for example, the traveling route allowing the vacuum cleaner 11 to reciprocatively travel in one portion. In an example, the travel control part 61 controls the driving of the driving wheels 21 (the motors 33) so that the vacuum cleaner 11 (the main casing 20) repeats the operation including the steps of reciprocating twice on one straight line, moving to an adjacent straight line, and further reciprocating twice on the adjacent straight line. Such control enables to effectively clean the rug type.

The cleaning control part 62 further preferably controls the cleaning unit 22 to operate variously depending on the types of floor surfaces discriminated by the discrimination part 64. In an example, in the case where the type of a floor surface is tatami mat, when the vacuum cleaner 11 turns during zigzag traveling, the cleaning control part 62 reduces (may stop) the driving of the cleaning unit 22, thereby enabling to effectively suppress the meshes of the tatami mats from being scratched. Specially, in the case where the traveling route set by the route setting part 66 includes some parts in which the vacuum cleaner 11 travels against the mesh directions of tatami mats, the cleaning control part 62 reduces (may stop) the rotating force of the rotary brush 36 (the brush motor 37), thereby enabling to effectively reduce the meshes of the tatami mats from being scratched due to the rotation of the rotary brush 36 coming into contact with the tatami mats.

In another example, in the case where the type of a floor surface is rug type, the cleaning control part 62 increases the driving force of the cleaning unit 22, thereby enabling to effectively clean the rug type. Specifically, in the case where the discrimination part 64 discriminates that the type of a floor surface is rug type, the cleaning control part 62 increases at least one of the suction force of the electric blower 35, the rotating force of the rotary brush 36 (the brush motor 37), and the rotating force of the side brushes 38 (the side brush motors 39), thereby enabling to carefully clean the rug type. In this case, the travel control part 61 controls the driving of the driving wheels 21 (the motors 33) to reduce the traveling speed of the vacuum cleaner 11 (the main casing 20), thereby increasing the cleaning force by the cleaning unit 22 at every position of the floor surface, resulting in providing more effective cleaning.

In the case where the positional relation between the current self-position and the positions of traveling obstacles, the positions of specific shapes, or the position information on the floor surface at the time of the cleaning after the map generation part 65 generates the map, differs from the relation stored in the map, the map generation part 65 corrects the self-position each time, thereby eliminating the integrated errors of the position of the vacuum cleaner 11 in the cleaning area to grasp the accurate position. Such operation allows the vacuum cleaner 11 to travel along a traveling route with high precision. That is, the map generation part 65 corrects the self-position of the vacuum cleaner 11 on the basis of the detection of specific shapes. Moreover, a user may be notified of the traveling route set by the route setting part 66 or the traveling track of the vacuum cleaner 11 (the main casing 20). In this case, for example, the communication part 25 is used to transmit the traveling route or the traveling track to a server on a network or the like via the home gateway, whereby a user is able to access the sever via the Internet by use of an external device such as a smart phone or a PC owned by the user, an external device is able to be notified by a mail, or a dedicated external device is able to monitor the traveling route or the traveling track. Moreover, the traveling route or the traveling track is able to be indicated on the indication unit or the like of the vacuum cleaner 11.

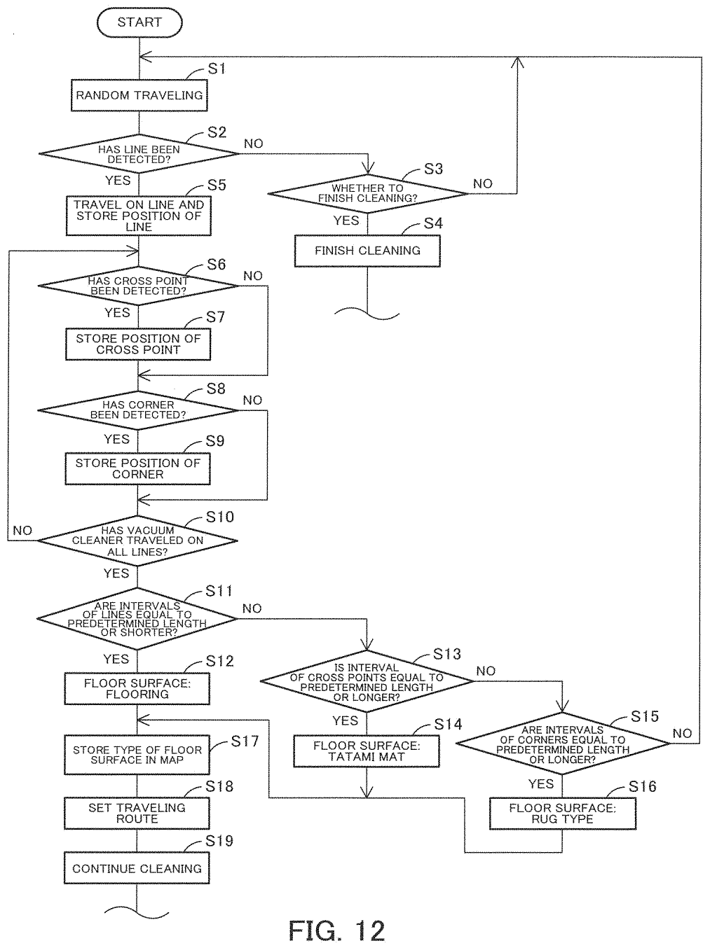

The above operation and control are described below with reference to the flowchart indicated in FIG. 12. The control is roughly divided into a detection phase for detecting specific shapes, a discrimination phase for discriminating the type of a floor surface and registering the type of the floor surface or the like into the map, a setting phase for setting a traveling route on the basis of the discriminated type of the floor surface, and a cleaning phase for performing cleaning while traveling along the traveling route.

<Detection phase>

When the cleaning is started, firstly, the travel control part 61 controls the driving of the driving wheels (the motors 33) so that the vacuum cleaner 11 (the main casing 20) travel in an ordinary manner, for example, random traveling (step S1). Thereafter, the determination is made, of whether or not the discrimination part 64 has detected a line as a specific shape on the basis of the detection by the sensor part 23 or the images captured by the cameras 51, in a specific distance area in the advancing direction of the vacuum cleaner 11 (the main casing 20) (step S2). In the case where the discrimination part 64 discriminates that any line has not been detected in step S2, the determination is made, of whether or not the vacuum cleaner 11 should finish the cleaning (step S3). Then, in the case where the cleaning is determined to be finished in step S3, the vacuum cleaner 11 finishes the cleaning (step S4), and returns to, for example, the charging device. Moreover, in the case where the cleaning is determined not to be finished in step S3, the processing proceeds to step S1.

In the case where the discrimination part 64 discriminates that a line has been detected in step S2, the travel control part 61 controls the driving of the driving wheels 21 (the motors 33) so that the vacuum cleaner 11 (the main casing 20) travels on the line, and the map generation part 65 stores the position of the line on the map (step S5).

Thereafter, the discrimination part 64 discriminates whether or not a cross point (for example, a letter-T shape) has been detected as a specific shape (step S6). In the case where the discrimination part 64 discriminates that a cross point has been detected in step S6, the map generation part 65 stores the position of the cross point on the map (step S7). On the other hand, in the case where the discrimination part 64 discriminates that any cross point has not been detected in step S6, the processing proceeds to step S8.

Furthermore, the discrimination part 64 discriminates whether or not a corner has been detected as a specific shape (step S8). In the case where the discrimination part 64 discriminates that a corner has been detected in step S8, the map generation part 65 stores the position of the corner on the map (step S9). On the other hand, in the case where the discrimination part 64 discriminates that any corner has not been detected in step S8, the processing proceeds to step S10 as it is.

It is noted that the order of the processing in step S6 to step S7 and the processing in step S8 to step S9 does not matter.

Then, the travel control part 61 discriminates whether or not the vacuum cleaner 11 (the main casing 20) has traveled on all of the lines (step S10). In the case where the travel control part 61 discriminates that the vacuum cleaner 11 has not completed the traveling on all of the lines in step S10, the processing proceeds to step S6. Moreover, in the case where the travel control part 61 discriminates that the vacuum cleaner 11 has traveled on all of the lines in step S1°, the processing proceeds to step S11.

<Discrimination Phase>

The route setting part 66 discriminates whether or not the intervals between the detected lines are equal to a predetermined length or shorter, for example, 200 mm or shorter (step S11). In the case of discriminating that the intervals between the lines are equal to a predetermined length (200 mm) or shorter in step S11, the route setting part 66 discriminates that the type of the floor surface is flooring (step S12). Moreover, in the case of discriminating that the intervals between the lines are not equal to a predetermined length or shorter (longer than a predetermined length) in step S11, the route setting part 66 discriminates whether or not the minimum interval of the detected cross points is equal to a predetermined length or longer, for example, 800 mm or longer (step S13). In the case of discriminating that the minimum interval of the detected cross points is equal to a predetermined length (800 mm) or longer in step S13, the route setting part 66 discriminates that the type of the floor surface is tatami mat (step S14). Moreover, in the case of discriminating that the minimum interval of the detected cross points is not equal to a predetermined length or longer (shorter than a predetermined length) in step S13, the route setting part 66 discriminates whether or not the intervals of the detected corners are equal to a predetermined length, for example, 500 mm, or longer (step S15). In the case of discriminating that the intervals of the detected corners are equal to a predetermined length (500 mm) or longer in step S15, the route setting part 66 discriminates that the type of the floor surface is rug type (step S16). Moreover, in the case of discriminating that the intervals of the detected corners are not equal to a predetermined length or longer (shorter than a predetermined length) in step S15, the route setting part 66 discriminates that the type of the floor surface is another type of a floor surface than flooring, tatami mat and rug type, and the processing proceeds to step S1. It is noted that the order of the processing in step S11 to step S12, the processing in step S13 to step S14, and the processing in step S15 to step S16 does not matter. After each of step S12, step S14 and step S16, the map generation part 65 stores the discriminated type of the floor surface on the map (step S17).

<Setting Phase>

After step S17, the route setting part 66 sets a traveling route depending on the discriminated type of the floor surface (step S18).

<Cleaning Phase>

After step S18, the vacuum cleaner 11 continues the cleaning (step S19). In step S19, the travel control part 61 controls the operation of the driving wheels 21 (the motors 33) to make the vacuum cleaner 11 (the main casing 20) travel along the traveling route set by the route setting part 66. Moreover, the cleaning control part 62 drives the cleaning unit 22 to clean a floor surface. In this case, the cleaning control part 62 is able to control the cleaning unit 22 to operate variously depending on the types of floor surfaces.

After traveling along the entire traveling route set by the route setting part 66, the vacuum cleaner 11 performs a predetermined operation, for example, finishing the cleaning and returning to the charging device.

According to the embodiment described above, the route setting part 66 sets a traveling route on the basis of the map generated by the map generation part 65 and the discriminated type of a floor surface by the discrimination part 64, thereby enabling to set an optimum traveling route depending on the type of a floor surface. Accordingly, the travel control part 61 controls the driving of the driving wheels 21 (the motors 33) to make the vacuum cleaner 11 (the main casing 20) autonomously travel along the traveling route set by the route setting part 66, thereby enabling to provide efficient cleaning depending on the type of a floor surface. That is, unlike the case where a traveling route is set simply on the basis of the map generated by the map generation part 65, a traveling route is set in consideration of the type of a floor surface, thereby enabling to solve problems such as traveling against the mesh directions of tatami mats, difficulty in removing of the dust and dirt entering in the grooves of flooring, and difficulty in removing of the dust and dirt deeply intruding in the shaggy rug type.

The discrimination part 64 discriminates the type of a floor surface on the basis of specific shapes in the images captured by the cameras 51. Accordingly, the discrimination part 64 is able to detect the material effective for discriminating the type of a floor surface in an easy manner with higher precision, in comparison with the case where the features of a floor surface is sensed on the basis of the torque of the motors 33 for driving the driving wheels 21 and/or the reflection of light on a floor surface, as an example.

Furthermore, each of the cameras 51 is configured to capture an image to be used in generating the map of a cleaning area and detecting a traveling obstacle. Therefore, the discrimination of the type of a floor surface by use of the images captured by the cameras 51 does not require additional dedicated image capturing means for discrimination of the type of a floor surface, thereby allowing the vacuum cleaner 11 in a simple configuration.

The map generation part 65 stores the positions of specific shapes in the map, whereby the discrimination part 64 is able to easily utilize the positions, the intervals or the like of the specific shapes at the time of discriminating the type of a floor surface. Accordingly, the precision in discrimination of the type of a floor surface is improved.

The detection of lines as specific shapes allows the detection of, for example, a tatami border, a groove of flooring, a boundary between a rug type and the floor surface under the rug type, or the like. Accordingly, the discrimination part 64 is able to detect the discrimination material effective for discriminating the type of a floor surface in an easy manner with high precision.

In this case, the travel control part 61 controls the driving of the driving wheels 21 (the motors 33) to make the vacuum cleaner 11 (the main casing 20) travel along the line, thereby suppressing a floor surface, specially tatami mats, from being scratched by the driving wheels 21 and the rotary brush 36 even before the type of a floor surface is not discriminated yet.

The detection of cross points of lines as specific shapes allows the detection of, for example, corners of tatami mats, grooves of flooring or the like on the basis of the positions and the intervals of the cross points. Accordingly, the discrimination material is able to be detected, which is effective when the discrimination part 64 discriminates the type of a floor surface in an easy manner with high precision.

The detection of corners as specific shapes allows the detection of, for example, corners of a rug type or the like, on the basis of the positions and the intervals of the corners. Accordingly, the discrimination material is able to be detected, which is effective when the discrimination part 64 discriminates the type of a floor surface in an easy manner with high precision.

The discrimination part 64 discriminates the type of a floor surface on the basis of the distribution such as of the numbers of specific shapes and the detection intervals of specific shapes, resulting in enabling to discriminate the type of a floor surface with high precision.

The discrimination part 64 discriminates the type of a floor surface on the basis of a plurality of specific shapes, by using the combination of plural types of detection of the specific shapes, resulting in enabling to discriminate the type of a floor surface with high precision.

In the case where the discrimination part 64 discriminates that the type of a floor surface is tatami mat, the route setting part 66 sets a traveling route along the mesh directions of the tatami mats, on the basis of the arrangement of the tatami mats estimated on the basis of the distribution of the specific shapes, thereby suppressing the tatami mats from being scratched by the driving wheels 21 and the rotary brush 36.

In this case, the route setting part 66 sets the traveling route on the tatami mats on the basis of the widths of the lines detected as specific shapes, thereby enabling to efficiently estimate the arrangement of the tatami mats and the mesh directions thereof on the basis of the difference in width of the tatami borders and enabling to improve efficiency in setting of the traveling route by the route setting part 66.

Then, the discrimination part 64 discriminates the type of a floor surface on the basis of the specific shapes such as lines, cross points and corners captured by the cameras as described above, resulting in enabling to easily discriminate the type of a floor surface without advanced image processing.

In the case where the traveling route set by the route setting part 66 has some parts in which the vacuum cleaner 11 travels against the mesh directions of tatami mats, the cleaning control part 62 reduces the rotating force of the rotary brush 36 (the brush motor 37), thereby enabling to reduce the risk of the scratching to the tatami mats by the rotary brush 36.

In the case where the discrimination part 64 discriminates that the type of a floor surface is flooring, the route setting part 66 sets a traveling route along the grooves on the basis of the distribution of the specific shapes, thereby enabling to efficiently remove the dust and dirt entering in the grooves of the flooring.

In the case where the discrimination part 64 discriminates that the type of a floor surface is rug type, the route setting part 66 sets a traveling route allowing the vacuum cleaner 11 to reciprocatively travel in the region of the rug type estimated on the basis of the distribution of the specific shapes, thereby enabling to carefully clean the rug type to more surely remove the dust and dirt deeply intruding into the shaggy rug type or the like.

The cleaning control part 62 controls the cleaning unit 22 to operate variously depending on the types of floor surfaces discriminated by the discrimination part 64, thereby enabling to perform more effective cleaning depending on the types of floor surfaces. In an example, in the case of the cleaning on a rug type, the cleaning control part 62 increases the cleaning force of the cleaning unit 22 (the suction force of the electric blower 35, the rotating force of the rotary brush 36 (the brush motor 37), or the rotating force of the side brushes 38 (the side brush motors 39)), or the travel control part 61 controls the driving of the driving wheels 21 (the motors 33) to reduce the traveling speed of the vacuum cleaner 11 (the main casing 20).

The correction of the self-position based on the detection of specific shapes allows the elimination of integrated errors of the self-position, thereby enabling to perform the cleaning along the traveling route with high precision.

Then, for example, the communication part 25 is used to notify a user of the traveling route or the traveling track of the vacuum cleaner 11 (the main casing 20), thereby enabling to notify the user of the cleaning performance and to give the user a sense of security.

Here, in the description of the above embodiment, the function of the self-position estimation means is integrally provided in the map generation part (mapping means) 65. Alternatively, the function may be provided separately from the map generation part 65.

Moreover, in the configuration described above, the vacuum cleaner 11 includes the cameras 51, and discriminates the type of a floor surface on the basis of the images captured by the cameras 51. Alternatively, the vacuum cleaner 11 may be configured to exchange data with the camera disposed on, for example, a ceiling in a cleaning area, through wireless communication, wired communication or the like, thereby discriminating the type of a floor surface on the basis of the image captured by the camera disposed on the ceiling or the like.

Furthermore, in the configuration described above, the traveling route or the traveling track of the vacuum cleaner 11 is transmitted to an external device via the communication part 25, and indicated on the external device, whereby a user is notified of the traveling route or the traveling track. Alternatively, for example, the indication part of the vacuum cleaner 11 may be used as notification means, and thus the traveling route or the traveling track may be indicated directly on the indication part.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

(1) The method of controlling traveling of a vacuum cleaner including the steps of generating a map of a cleaning area on a basis of estimation of a self-position, discriminating a type of a cleaning-object surface, and setting a traveling route on a basis of the map and the discriminated type of the cleaning-object surface to make a main body autonomously travel along the set traveling route.

(2) The method of controlling the traveling of the vacuum cleaner according to (1), the method including the step of discriminating the type of the cleaning-object surface on a basis of a specific shape in an image captured by a camera.

(3) The method of controlling the traveling of the vacuum cleaner according to (2), the method including the step of storing a position of the specific shape in the map.

(4) The method of controlling the traveling of the vacuum cleaner according to (2) or (3), the method including the step of storing a position of a line as a specific shape in the map.

(5) The method of controlling the traveling of the vacuum cleaner according to (4), the method including the step of making the main body autonomously travel along the line.

(6) The method of controlling the traveling of the vacuum cleaner according to (2) or (3), the method including the step of storing a cross point of lines as a specific shape in the map.

(7) The method of controlling the traveling of the vacuum cleaner according to (2) or (3), the method including the step of storing a corner as a specific shape in the map.

(8) The method of controlling the traveling of the vacuum cleaner according to any one of (2) to (7), the method including the step of discriminating the type of the cleaning-object surface on a basis of a distribution of the specific shapes.

(9) The method of controlling the traveling of the vacuum cleaner according to anyone of (2) to (7), the method including the step of discriminating the type of the cleaning-object surface on a basis of a plurality of the specific shapes.

(10) The method of controlling the traveling of the vacuum cleaner according to any one of (2) to (9), the method including the step of, in a case of the type of the cleaning-object surface discriminated as being tatami mat, setting the traveling route along a mesh direction of the tatami mat, on a basis of arrangement of the tatami mat estimated on the basis of the distribution of the specific shapes.

(11) The method of controlling the traveling of the vacuum cleaner according to (10), the method including the step of setting the traveling route on the tatami mat on a basis of a width of the line as the specific shape.

(12) The method of controlling the traveling of the vacuum cleaner according to (10) or (11), the method including the step of reducing a force of rotation of a rotary cleaner configured to scrape up dust and dirt on the cleaning-object surface, in a case of the set traveling route having a position allowing the main body to travel against the mesh direction of the tatami mat.

(13) The method of controlling the traveling of the vacuum cleaner according to any one of (2) to (12), the method including the step of, in a case of the type of the cleaning-object surface discriminated as being flooring, setting the traveling route along a groove on the basis of the distribution of the specific shapes.

(14) The method of controlling the traveling of the vacuum cleaner according to any one of (2) to (13), the method including the step of, in a case of the type of the cleaning-object surface discriminated as being rug type, setting the traveling route allowing the main body to reciprocatively travel in a region of the rug type estimated on the basis of the distribution of the specific shapes.

(15) The method of controlling the traveling of the vacuum cleaner according to any one of (1) to (14), the method including the step of controlling a cleaning unit to operate variously depending on the discriminated type of the cleaning-object surface, the cleaning unit being configured to clean the cleaning-object surface.

(16) The method of controlling the traveling of the vacuum cleaner according to any one of (1) to (15), the method including the step of correcting the self-position on a basis of detection of the specific shape.

(17) The method of controlling the traveling of the vacuum cleaner according to any one of (1) to (16), the method including the step of performing notification of the traveling route or a traveling track.

1. A vacuum cleaner comprising:
a main body;
a travel driving part configured to allow the main body to travel;
a cleaning unit configured to perform cleaning;
a self-position estimation part configured to perform estimation of a self-position;
a mapper configured to generate a map of a cleaning area on a basis of the estimation of the self-position by the self-position estimation part;
a discrimination part configured to discriminate a type of a cleaning-object surface;
a setting part configured to set a traveling route on a basis of the map generated by the mapper and the type of the cleaning-object surface discriminated by the discrimination part; and
a travel controller configured to control driving of the travel driving part to make the main body autonomously travel along the traveling route set by the setting part.

2. The vacuum cleaner according to claim 1, wherein
the discrimination part discriminates the type of the cleaning-object surface on a basis of a specific shape in an image captured by a camera capable of capturing an image of the cleaning-object surface.

3. The vacuum cleaner according to claim 2, wherein
the mapper stores a position of the specific shape in the map.

4. The vacuum cleaner according to claim 2, wherein
the specific shape is a line.

5. The vacuum cleaner according to claim 4, wherein
the travel controller controls the driving of the travel driving part so as to make the main body travel along the line.

6. The vacuum cleaner according to claim 2, wherein
the specific shape is a cross point of lines.

7. The vacuum cleaner according to claim 2, wherein
the specific shape is a corner.

8. The vacuum cleaner according to claim 2, wherein
the discrimination part discriminates the type of the cleaning-object surface on a basis of a distribution of the specific shapes.

9. The vacuum cleaner according to claim 2, wherein
the discrimination part discriminates the type of the cleaning-object surface on a basis of a plurality of the specific shapes.

10. The vacuum cleaner according to claim 2, wherein
when the discrimination part discriminates the type of the cleaning-object surface as being tatami mat, the setting part sets the traveling route along a mesh direction of the tatami mat, on a basis of arrangement of the tatami mat estimated on the basis of the distribution of the specific shapes.

11. The vacuum cleaner according to claim 10, wherein
the setting part sets the traveling route on the tatami mat on a basis of a width of the line as the specific shape.

12. The vacuum cleaner according to claim 10, the vacuum cleaner comprising:
a rotary cleaner configured to scrape up dust and dirt on the cleaning-object surface by rotation; and
rotation controller configured to control the rotation of the rotary cleaner, wherein
the rotation controller reduces a force of the rotation of the rotary cleaner when the traveling route set by the setting part has a part allowing the main body to travel against the mesh direction of the tatami mat.

13. The vacuum cleaner according to claim 2, wherein
when the discrimination part discriminates the type of the cleaning-object surface as being flooring, the setting part sets the traveling route along a groove on the basis of the distribution of the specific shapes.

14. The vacuum cleaner according to claim 2, wherein
when the discrimination part discriminates the type of the cleaning-object surface as being rug type, the setting part sets the traveling route allowing the main body to reciprocatively travel in a region of the rug type estimated on the basis of the distribution of the specific shapes.

15. The vacuum cleaner according to claim 1, the vacuum cleaner comprising:
A cleaning controller configured to control the cleaning unit to operate variously depending on the type of the cleaning-object surface discriminated by the discrimination part.

16. The vacuum cleaner according to claim 1, wherein
the self-position estimation part corrects the self-position on a basis of detection of the specific shape.

17. The vacuum cleaner according to claim 1, the vacuum cleaner comprising:
a notification part configured to perform notification of the traveling route or a traveling track.
